(19) United States
(12) Patent Application Publication
(10) Pub. No.: US 2002/0043023 A1
(43) Pub. Date: Apr. 18, 2002

(54) SLAG HANDLING SYSTEM

(76) Inventor: WILLIAM M. DAVIS, JR., SUGAR LAND, TX (US)

Correspondence Address: STEPHEN H. CAGLE, HOWREY, SIMON, ARNOLD & WHITE, LLP, 750 BERING DRIVE, HOUSTON, TX, 77057, US

(21) Appl. No.: 08/265,858

(22) Filed: Jun. 27, 1994

(51) Int. Cl. C10J 3/00; C03B 18/00; C03B 37/00

(52) U.S. Cl. 48/DIG. 2; 48/69

(57) ABSTRACT

A batch slag handling system for gasifiers and the like which operate under pressure, has a lockhopper receiving the slag under pressure and dispensing it after depressurization. The slag is ground and combined with water for transport to a slag sump where it is dewatered and then removed from the site. Sluice water is provided by a closed loop system.

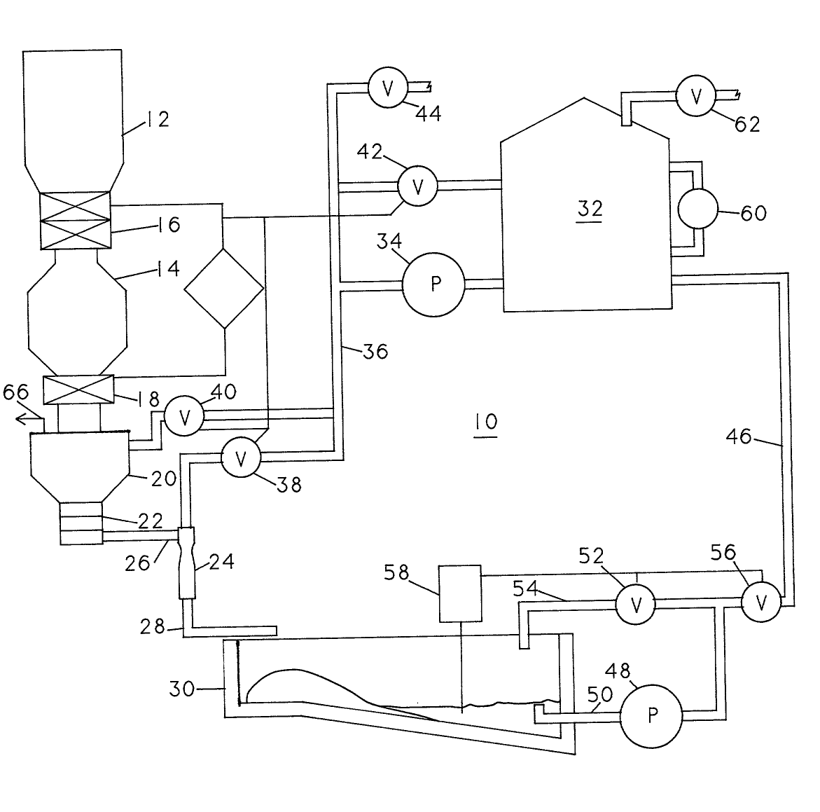

### BACKGROUND OF THE INVENTION

1. The Filed of the Invention

The present invention pertains to an improved slag handling system and, in particular, to a system which obviates the use of an expensive and unreliable drag conveyor.

2. The Prior Art

All coal and coke gasification systems must have slag removal systems to discharge the ash and nonvolatile materials which are unavoidable by-products of such processes. One present slag removal system incorporates a slag drag conveyor which receives slag directly from a lockhopper onto a conveyor belt which conveys the slag to a slag containment vessel (such as a truck, train, pit, etc). The slag producing sections of these gasification processes are in a harsh environment exposed to both erosive materials and corrosive chemicals. This harsh environment has caused the drag conveyors, with their many moving parts, to be failure prone, maintenance intensive, and thus unreliable for slag removal. The drag conveyors are very expensive, in and of themselves, and therefor spare or backup systems are too costly to be kept on site for emergency use. The unreliable nature of this type of slag removal equipment can lead to downtime for an entire gasification plant and thereby reduced onstream time/capacity factors. One known drag conveyor was such a major weak link in a gasification process that it was eventually bypassed by using an emergency slag dump line. In order to improve the reliability of gasification processes, an improved method of slag handling, which is environmentally acceptable, economical to maintain and operate, and safe to operate, is necessary.

Coal-fired boilers in other industries generate ash/slag material which is similar to, but not exactly the same as, the slag which results from gasification processes. However, unlike gasifiers, the slag producing portions of conventional boilers usually do not operate under pressure and therefor can have continuous removal of slag from the system. There are variations of sluicing systems used in these coal-fired boiler plants.

It is believed that the present invention can overcome at least some of the above discussed problems by significantly reducing unit downtime of coal and coke gasification plants and thereby improve capacity factors for potential customers. It will allow higher onstream times by reducing downtime for maintenance and repair of the slag removal system. The cost of the system should be considerably less than for a drag conveyor system, especially considering that plant maintenance costs will be substantially less.

### SUMMARY OF THE INVENTION

The present invention provides for the removal of slag from a gasification system operated under pressure by using a lock hopper to receive, depressurize and dispense batches of slag. The slag passes through a discharger, where it is ground to sufficiently small size to pass through the rest of the system without causing any jamming. The ground slag is passed to an eductor where it is mixed with water, from a closed loop sluice water system, and sent to a slag pit. The water level in the slag pit is monitored and returned to the closed loop sluice water system.

### BRIEF DESCRIPTION OF THE DRAWINGS

The present invention will now be described, by way of example, with reference to the accompanying drawings, in which the single FIGURE is a schematic diagram of the present invention.

### DETAILED DESCRIPTION OF THE PREFERRED EMBODIMENT

The subject system 10 is preferably used in conjunction with, and as part of, a known coal or coke gasification plant, of which only the slag receiving sump 12 has been shown. The sump 12 usually has therein grinding means (not shown) to break up the slag it receives from the gasifier operation. The slag handling portion of the subject system has a lockhopper 14 with a first pressure lock 16 connecting the output of sump 12 to the input of lockhopper 14 and a second pressure lock 18 serving for its output. A slag discharger 20 is connected between the second pressure lock 18 and slag grinder 22, where the slag is ground and reduced in size so as not to plug the downstream equipment. The ground slag is passed through pipe 26 to eductor 24 where it is mixed with water and sent through pipe 28 to the sump pit 30.

The system also includes a closed loop sluice water portion in which tank 32 serves as the primary source of sluice water. A sluice water pump 34 is connected to an output of tank 32 and by distribution piping 36 through valve 38 to eductor 24, valve 40 to discharger 20, valve 42 back to the tank 32, and valve 44 to a grey water treatment facility (not shown). Forming the return portion of the closed loop is sump piping 46 having pump 48 connected to the sump pit drain line 50, valve 52 connected to a return line 54 to the sump pit 30, and valve 56 to the sluice water tank 32. Valves 52 and 56 are controlled by sump level sensing and control means 58. The sluice water tank 32 includes level control means 60 and inlet valve 62 connected to a make up water source (not shown). Valve 44 connects the close loop to a gray water treatment facility (not shown) to grey water to dispose of overly contaminated water. A control 64 controls the operation of the pressure locks 16, 18, and valves 38, 40, 42, as described below. The discharger 20 preferably is equipped with a vent 66 connected to vapor recovery means (not shown).

Slag accumulates in the lockhopper 14, according to normal gasifier operation, by periodic actuation of pressure lock 16. The pressure lock 18 is likewise be periodically actuated, but only when pressure lock 16 is closed, to dump the accumulated slag into discharger 20. Some sluice water is admitted to the discharger through valve 40 and some vapor is discharged through vent 66. The discharger then discharges the partially cooled and depressurized slag to slag grinder 22 where it is reduced in size sufficiently so as to not cause clogging problems downstream. Ground slag is then be fed to the sluicing water eductor 24 where it is mixed with sluice water and hydraulically transferred to the slag pit 30.

The slag pit 30 is constructed to promote efficient dewatering of the slag. Slag pit water will be pumped by pump 48 through piping 46 to sluice water tank 32, where residence time can be provided for solids settling. High volume pump 34 provides sluice water through valve 38 and the eductor 24 to the slag pit 30.

Level control system 58 maintains a minimum water level in the slag pit 30 by selectively actuating valves 52 and 56 and pump 48. Level control system 60 maintains a sufficient quantity of water in the sluice water tank 32, by actuating valve 62, to assure a full slag dump cycle.

The total closed loop sluice water system preferably is sized to maintain a water balance. Occasional excess water is passed to a grey water treatment system (not shown) through valve 44.

The discharger 20 is a commercially available piece of equipment and a suitable example is the Roplex Discharger manufactured by the Hindon Corporation of Charleston, S.C. It is designed with a unique internal configuration and a bottom dump rotary plow which provides uniform discharge feed and eliminates vessel plugging. The discharger 20 discharges into slag grinder 22 which reduces slag size to dimensions which will not plug downstream equipment in the path to the slag pit 30.

The slag pit will preferably have multiple slag entry points. When a section of the pit becomes full, an alternate entry location will be selected and opened. The pit will be designed for efficient dewatering of the slag piles. After a predetermined period, to allow for additional dewatering, the dewatered slag can be loaded into trucks and hauled off site.

The low end of the slag pit will collect water runoff from the incoming slag. The slag pit water pump 48 pumps the water from the slag pit sump to either recirculate it to the pit through valve 52 or to the sluice water tank 32 through valve 56. System design should enable the slag water pump 48 to run continuously to reduce on/off operation pump stress and to prevent solids from settling in the lines 46, 50, 54 and pump 48. If the sump level becomes low, the slag pit sump level control 58 will open the water return valve 52 and close the water valve 56 to the sluice water tank 32 to maintain the minimum sump level required to prevent loss of suction to the pump 48. If the sump level drops below a low-low level point, the pump 48 will shut down.

The sluice water tank 32 normal operating range will provide adequate water supply to sustain the sluicing system through a complete slag lock hopper dump cycle. A level control system 60 will maintain the proper level in the sluice water tank, providing make-up water through valve 62 during low level conditions and rejecting excess water through valve 44 to a grey water treatment system (not shown) during high level conditions. The tank 32 will provide residence time for additional solids settling. This will help to protect the downstream, high volume, sluice water pump 34 and the slag eductor 24 from unnecessary erosion. Solids settling will also provide a cleaner source of water for rejection to the grey water system. Accumulated solids will need to be cleaned out periodically, or a cone bottom tank can be used incorporating a solids removal system. If the closed sluice water system requires chemical additions for water quality, the tank 32 will provide a suitable injection/mixing point.

The sluicing water control valves 38, 40, and 42 will operate in conjunction with the interlock/timing system of the lock hopper 14. When the lock hopper 14 is in the collect mode, the sluice water valve 38 to the slag eductor 24 and the flush water valve 40 to the slag tank 20 will be closed. Sluice water return valve 42 to the tank 32 will be open. System design should enable the sluice water pump 34 to run continuously to reduce on/off operation pump stress and to prevent solids settling in the lines and pump. When the lock hopper 14 completes the depressurization step, valve 38 will open to provide sluice water to the system and valve 42 will close. The flush water valve 40 will open to allow the necessary flush of water to the discharger 20. This flush will help slag move through the discharger 20, through the slag grinder 22 and into the eductor 24. At the completion of the sluicing cycle, a timing control system will open valve 42 and close valves 38 and 40.

The present invention may be subject to many modifications and changes, which will become apparent to one skilled in the art, without departing from the spirit or essential characteristics thereof. Thus the above described embodiment should be considered in all respects as illustrative and not restrictive of the scope of the present invention as defined by the appended claims.

I claim:

1. A slag handling system comprising:
slag sump receiving slag therein directly from a slag generating operation;
lockhopper means connected to receive slag discharged from the slag sump, said lockhopper having both input and output airlock means;
slag grinding means connected to receive slag output from said lockhopper;
a closed loop sluice water system;
eductor means connected to receive the output of said grinder, water from said sluice water system, mix said slag and said water, and to feed said watered slag to a sump pit; and
means to monitor water level in said sump pit.

2. A slag handling system according to claim 1 wherein said closed loop sluice water system includes:
means to monitor and maintain the level of water in said sump pit.

3. A slag handling system according to claim 1 wherein said closed loop sluice water system includes:
holding tank means and means to monitor and maintain the level of sluice water in said holding tank.

4. A slag handling system according to claim 1 wherein said closed loop sluice water system includes:
means to monitor and maintain a water level in said eductor.

5. A slag handling system according to claim 1 wherein said closed loop sluice water system includes:
a source of water.

6. A slag handling system according to claim 1 wherein said closed loop sluice water system includes:
means connecting said closed loop to a gray water treatment means.

7. A method for handling slag generated as a byproduct of an operation carried out under pressure and at high temperatures, said method comprising the steps of:
providing a sump to collect slag generated by said operation;
periodically removing accumulated slag in batches through airlock means preserving the pressurized condition of said operation;
initially cooling and depressurizing said slag;
dispensing said cooled and depressurized slag to grinding means which reduces the slag to ground material;
passing the ground material to an eductor where it is combined with water and flowed to a collection sump;
monitoring the water in said sump; and
collecting and recirculating the water from said sump to collecting tanks and to said eductor.

8. The method according to claim 7 further comprising:
means to monitor the water in the collection tank.

9. The method according to claim 7 further comprising:
means to add water to said system.

10. The method according to claim 7 further comprising:
means to dispose of at least part of said water to gray water treatment means.
